(19) United States
(12) Patent Application Publication
(10) Pub. No.: US 2026/0125516 A1
(43) Pub. Date: May 7, 2026

(54) WATER-RESISTANT CONDUCTIVE HYDROGEL AND METHOD OF PREPARING SAME

(71) Applicant: BIO-PROTECH INC., Wonju-si (KR)

(72) Inventors: Jae-Chan KIM, Wonju-si (KR); Sun-Jong LEE, Seongnam-si (KR); Dong-Min KIM, Asan-si (KR); Ye-Won JU, Pyeongtaek-si (KR)

(21) Appl. No.: 19/380,109

(22) Filed: Nov. 5, 2025

(30) Foreign Application Priority Data
Nov. 6, 2024 (KR) 10-2024-0155763

(51) Int. Cl. C08J 3/075; C08J 3/24; C08J 3/28

(52) U.S. Cl. CPC C08J 3/075; C08J 3/24; C08J 3/28; C08J 2333/02; C08J 2471/02; C08J 2481/00

(57) ABSTRACT

Described is a hydrogel having both an ion-conductive region based on an acrylic polymer and an electrically conductive region of poly(3,4-ethylenedioxythiophene) polystyrene sulfonate (PEDOT:PSS). In addition, described is a hydrogel to which poly(ethylene glycol) (PEG) or poly(ethylene glycol) methyl ether (PEGME) is added to improve the water resistance (or durability) of the hydrogel.

### CROSS REFERENCE TO RELATED APPLICATION

The present application claims priority to Korean Patent Application No. 10-2024-0155763, filed Nov. 6, 2024, the entire contents of which is incorporated herein for all purposes by this reference.

### BACKGROUND

### 1. Technical Field

The present disclosure relates to a hydrogel. Specifically, the present disclosure relates to a hydrogel having both an ion-conductive region based on an acrylic polymer and an electrically conductive region of poly(3,4-ethylenedioxythiophene) polystyrene sulfonate (PEDOT:PSS), which is a hydrogel with excellent water resistance (or durability).

### 2. Description of the Related Art

Polymeric conductive hydrogels are commonly used for various purposes, including medical electrodes, diapers, contact lenses, and cell culture. A hydrogel, a hydrophilic polymer cross-linked by cohesive forces such as covalent bonds, hydrogen bonds, van der Waals bonds, or physical bonds, contains a large amount of water in an aqueous solution and thus has a swellable network structure.

The present disclosure relates to a hydrogel used for medical electrodes, among hydrogels. While hydrogel adhesive patches for existing electrocardiogram (ECG) and electromyography (EMG) sensors have ionic conductivity based on acrylic adhesives, such hydrogels swell or deswell due to penetration or dissolution of moisture, as shown in FIG. 1. This results in unstable ionic conductivity, causing degradation of sensing capability and noise generation. In addition, conventional hydrogel patches exhibit poor water resistance and durability as the usage time increases, and become detachable during use, making long-term measurements impossible and causing discomfort to the users, which is problematic.

### DOCUMENT OF RELATED ART

### Patent Document

(Patent Document 1) Korean Patent Application Publication No. 10-2011-0042860

### SUMMARY

Conventional hydrogels swell or deswell due to evaporation or absorption of moisture, leading to changes in ionic conductivity. Due to such changes in ionic conductivity, noise is generated in the electrical signal, making it challenging to transmit an accurate electrical signal. In the meantime, the present disclosure aims to address the issue of such conventional hydrogels.

In particular, the present disclosure aims to address the above issue of a hydrogel containing an ion-conductive acrylic polymer as the main component.

In particular, the present disclosure aims to provide a hydrogel with improved durability and water resistance.

The present disclosure provides a hydrogel in which an acrylic polymer, PEDOT:PSS, and at least one of poly(ethylene glycol) (PEG) and poly(ethylene glycol) methyl ether (PEGME) as an additive are included in an ion-conductive acrylic polymer, in order to improve electrical conductivity, water resistance, and durability.

In particular, the hydrogel may include 1 to 100 parts by weight of PEDOT:PSS and 1 to 30 parts by weight of the additive, based on 100 parts by weight of the acrylic polymer.

In particular, PEG or PEGME, serving as the additive, may have a molecular weight in a range of 500 to 20,000.

In particular, the acrylic polymer may be a homopolymer of a first monomer having an acryl group, or a copolymer of a second monomer having a different functional group from that of the first monomer having an acryl group.

In particular, the first monomer having an acryl group may be acrylic acid, and the second monomer may be 2-acrylamido-2-methylpropane sulfonic acid (AMPS).

In addition, the present disclosure provides a method of preparing a hydrogel, the method including the following steps: (1) preparing a first solution including a monomer containing a first monomer having an acryl group, a cross-linker, a photoinitiator, an electrolyte, and deionized water; (2) preparing a second solution containing PEDOT:PSS and an alcohol solvent; (3) preparing a mixed solution of the first and second solutions; (4) mixing at least one of PEG and PEGME as an additive in the mixed solution; and (5) cross-linking the mixed solution, in which the additive is mixed, through ultraviolet (UV) irradiation.

In particular, 1 to 100 parts by weight of PEDOT:PSS and 1 to 30 parts by weight of the additive, based on 100 parts by weight of the monomer, may be mixed in the mixed solution.

In particular, the additive may have a molecular weight in a range of 500 to 20,000.

In particular, the monomer may include the first monomer having an acryl group and a second monomer having a functional group other than an acryl group.

In particular, the first monomer having an acryl group may be acrylic acid, and the second monomer may be AMPS.

In the present disclosure, a hydrogel is prepared by mixing an ion-conductive acrylic polymer with PEDOT:PSS, an electrically conductive polymer based on a miscible alcohol solvent. A hydrogel patch of the present disclosure, in which the acrylic polymer and PEDOT:PSS are mixed, is both ion-conductive and electrically conductive, thus enabling a stable electrical signal to be transmitted when applied to ECG and EMG sensors. In addition, PEG or PEGME, serving as additives, enables the manufacture of hydrogel products with water resistance and durability, making it possible to manufacture hydrogel products that transmit stable electrical signals for long periods of time.

### BRIEF DESCRIPTION OF THE DRAWINGS

FIG. 1 is a diagram illustrating swelling and deswelling of a conventional hydrogel containing an ion-conductive acrylic polymer caused by moisture;

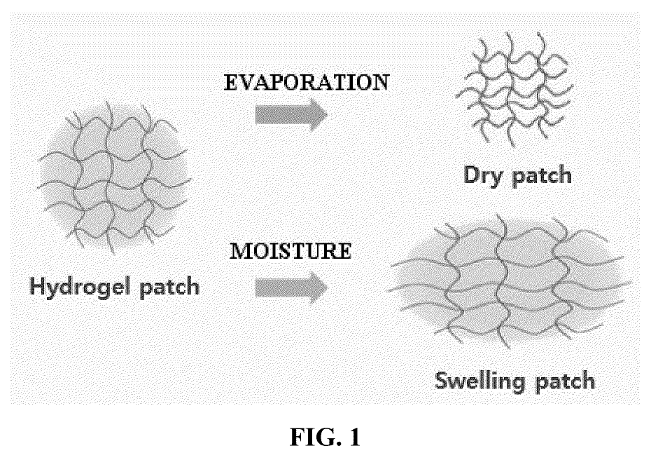

FIG. 2 is a diagram illustrating a difference between an existing hydrogel and a hydrogel of the present disclosure;

FIG. 3 is an image showing mixed solutions of a Comparative Example and Examples 1 to 8;

FIG. 4 is an image showing samples of a Comparative Example and Examples 1 to 8 after curing; and

FIG. 5 is an image showing water resistance test results for samples of a Comparative Example and Examples 1 to 8 after curing.

### DETAILED DESCRIPTION

In the following description, the term “polymer” is used in a broad sense to include “copolymer”.

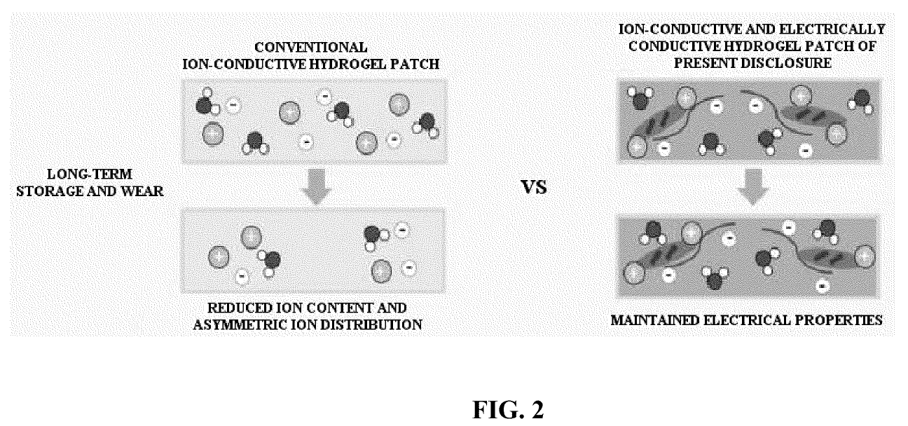

FIG. 2 is a diagram illustrating a difference between an existing hydrogel and a hydrogel of the present disclosure. The present disclosure is characterized by adding PEDOT:PSS, a polymer with excellent electrical conductivity, to an ion-conductive acrylic polymer hydrogel, in addition to an acrylic polymer, to improve electrical conductivity.

In PEDOT:PSS, the symbol “:” represents hydrogen bonding. However, PEDOT:PSS is not a copolymer but a mixture of PEDOT and PSS. PEDOT and PSS compensate each other in terms of charge, with PEDOT oligomers being strongly bound to the PSS polymer chains. Depending on the mixing ratio of PEDOT and PSS, the PEDOT:PSS solution can selectively exhibit hydrophilicity or hydrophobicity. In the present disclosure, PEDOT:PSS, a polymer with excellent electrical conductivity, is used as a component for imparting electrical conductivity to the hydrogel.

In addition, the present disclosure is characterized by using an “alcohol” solvent when preparing a mixed solution of PEDOT:PSS. When the solvent of PEDOT:PSS is water-based, the miscibility of the solvent with the acrylic monomer solution is significantly low, making the resulting hydrogel unsuitable for use. To address this issue, the present disclosure is characterized by improving the miscibility of the solvent with the acrylic monomer solution using alcohol-based PEDOT:PSS.

Furthermore, the present disclosure includes an additive, PEG or PEGME, as an essential component for improving water resistance or durability. It is understood that PEG or PEGME improves the water resistance and durability of the entire hydrogel through chemical bonding with PEDOT:PSS. However, further studies are required in this respect to clarify the theoretical basis.

In the present disclosure, 1 to 100 parts by weight of PEDOT:PSS and 1 to 30 parts by weight of the additive, with respect to 100 parts by weight of the acrylic polymer, may be used. In particular, the additive may have a molecular weight in the range of 500 to 20,000.

The acrylic polymer may be a homopolymer of a first monomer having an acryl group, or a copolymer of a second monomer having a different functional group from that of the first monomer having an acryl group. In particular, the first monomer having an acryl group may be acrylic acid, and the second monomer may be AMPS.

In addition, the present disclosure provides a method of preparing a hydrogel, the method including the following steps: (1) preparing a first solution including a monomer containing a first monomer having an acryl group, a cross-linker, a photoinitiator, an electrolyte, and deionized water; (2) preparing a second solution containing PEDOT:PSS and an alcohol solvent; (3) preparing a mixed solution of the first and second solutions; (4) mixing at least one of PEG and PEGME as an additive in the mixed solution; and (5) cross-linking the mixed solution, in which the additive is mixed, through UV irradiation.

In particular, 1 to 100 parts by weight of PEDOT:PSS and 1 to 30 parts by weight of the additive, based on 100 parts by weight of the monomer, may be mixed in the mixed solution. In particular, the additive may have a molecular weight in the range of 500 to 20,000. In addition, the monomer may be a mixed monomer of acrylic acid, serving as the first monomer having an acryl group as a functional group, and AMPS, serving as the second monomer.

Hereinafter, the present disclosure will be described in more detail through experiments.

### Example

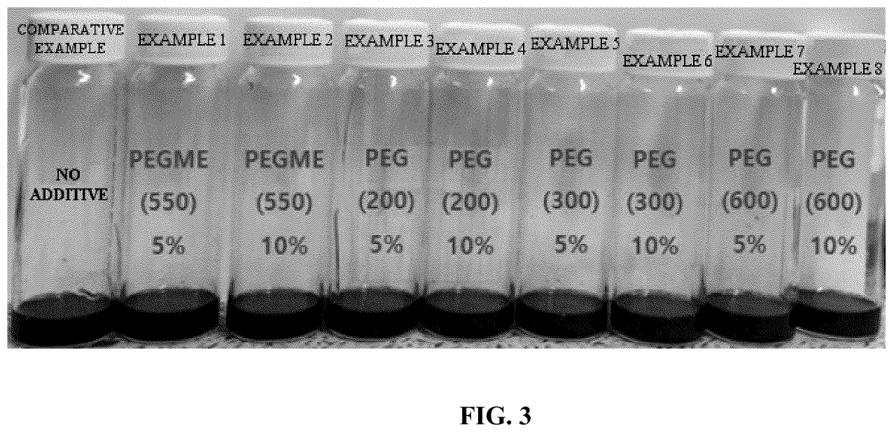

FIG. 3 is an image showing mixed solutions of a Comparative Example and Examples 1 to 8. As shown in Table 1 below, a total of nine samples were prepared.

TABLE 1

| | | Monomer | PEDOT:PSS | |
|---|---|---|---|---|
| Sample | | solution | solution | Additive |
| Comparative | | 8 g | 2 g | None |
| Example | | | | |
| Example | 1 | 8 g | 2 g | 0.5 g of PEGME |
| | | | | (Mw 550) |
| | 2 | 8 g | 2 g | 1 g of PEGME |
| | | | | (Mw 550) |
| | 3 | 8 g | 2 g | 0.5 g of PEG |
| | | | | (Mw 200) |
| | 4 | 8 g | 2 g | 1 g of PEG |
| | | | | (Mw 200) |
| | 5 | 8 g | 2 g | 0.5 g of PEG |
| | | | | (Mw 300) |
| | 6 | 8 g | 2 g | 1 g of PEG |
| | | | | (Mw 300) |
| | 7 | 8 g | 2 g | 0.5 g of PEG |
| | | | | (Mw 600) |
| | 8 | 8 g | 2 g | 1 g of PEG |
| | | | | (Mw 600) |

In this case, each monomer solution in Table 1 is an 8 g solution in total, including 0.96 g of acrylic acid serving as a first monomer, 1.28 g of AMPS serving as a second monomer, 0.008 g of a photoinitiator, and other components, such as an electrolyte (KCl) and deionized water. In addition, each PEDOT:PSS solution in Table 1 is a 2 g solution in which 0.5 wt % of PEDOT:PSS is dissolved in isopropyl alcohol (IPA) serving as a solvent.

### Experimental Example: Water Resistance (Durability) Test

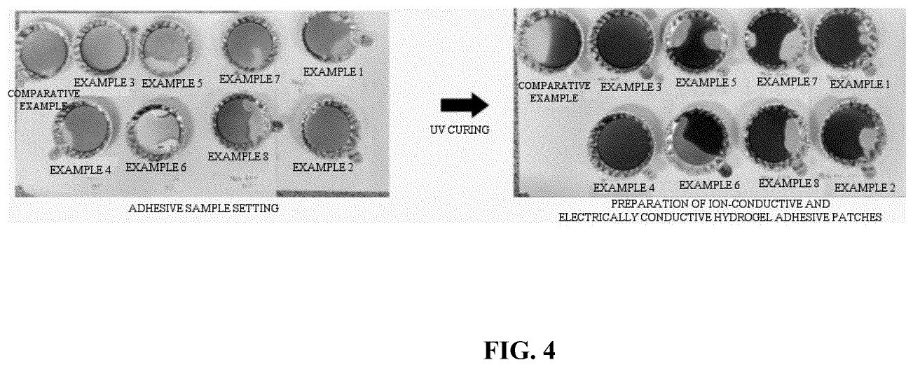

A water resistance test was conducted on the nine samples. For this test, nine aluminum plates serving as substrates were coated with the respective nine solutions and then cured through UV irradiation. FIG. 4 is an image showing the samples of the Comparative Example and Examples 1 to 8 after the curing.

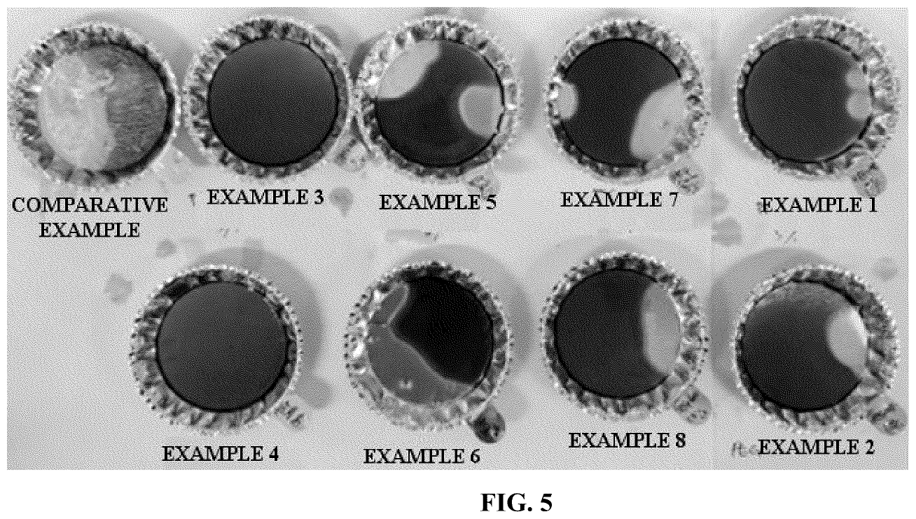

The water resistance test involved exposing each sample to running water for approximately 2 seconds, followed by observation of its shape. This test was repeatedly conducted three times on each sample. FIG. 5 is an image showing the water resistance test results, confirming that, in the sample of the Comparative Example located at the far left of the top row, the hydrogel was removed, resulting in a lighter color, whereas the samples of Examples 1 to 8 of the present disclosure were not dissolved in water and retained their original shapes. In other words, it was found that the samples of Examples 1 to 8 of the present disclosure exhibited excellent water resistance (and durability).

As described above, the water resistance test results showed that the adhesive patch of the Comparative Example, which did not contain the additive (PEG or PEGME), exhibited poor water resistance, whereas the adhesive patches of Examples 1 to 8, which contained the additive, were strongly resistant to moisture and showed excellent water resistance. These results indicate that the hydrogel patch of the present disclosure can not only be worn for a long period of time but also be utilized as a medical hydrogel patch capable of stably transmitting electrical signals.

What is claimed is:

1. A hydrogel comprising:
an acrylic polymer;
poly(3,4-ethylenedioxythiophene) polystyrene sulfonate (PEDOT:PSS); and
at least one of poly(ethylene glycol) (PEG) and poly(ethylene glycol) methyl ether (PEGME) as an additive.

2. The hydrogel of claim 1, wherein 1 to 100 parts by weight of PEDOT:PSS and 1 to 30 parts by weight of the additive, based on 100 parts by weight of the acrylic polymer, are mixed in the hydrogel.

3. The hydrogel of claim 1, wherein the additive has a molecular weight in a range of 500 to 20,000.

4. The hydrogel of claim 1, wherein the acrylic polymer is a homopolymer of a first monomer having an acryl group, or a copolymer of a second monomer having a different functional group from that of the first monomer.

5. The hydrogel of claim 4, wherein the first monomer is acrylic acid, and
the second monomer is 2-acrylamido-2-methylpropane sulfonic acid (AMPS).

6. A method of preparing a hydrogel, the method comprising:
(1) preparing a first solution comprising a monomer comprising a first monomer having an acryl group, a cross-linker, a photoinitiator, an electrolyte, and deionized water;
(2) preparing a second solution comprising PEDOT:PSS and an alcohol solvent;
(3) preparing a mixed solution of the first and second solutions;
(4) mixing at least one of PEG and PEGME as an additive in the mixed solution; and
(5) cross-linking the mixed solution, in which the additive is mixed, through ultraviolet (UV) irradiation.

7. The method of claim 6, wherein 1 to 100 parts by weight of PEDOT:PSS and 1 to 30 parts by weight of the additive, with respect to 100 parts by weight of the monomer, are mixed in the mixed solution.

8. The method of claim 6, wherein the additive has a molecular weight in a range of 500 to 20,000.

9. The method of claim 6, wherein the monomer is a mixed monomer of the first monomer and a second monomer having a functional group other than an acryl group.

10. The method of claim 9, wherein the first monomer is acrylic acid, and
the second monomer is AMPS.
